(19) United States
(12) Patent Application Publication
(10) Pub. No.: US 2026/0326053 A1
(43) Pub. Date: Oct. 22, 2026

(54) APPARATUS WITH SQUEEZING MEANS FOR PASSIVE MIXING OF MULTI-PHASE FLOW

(71) Applicant: SRAVATHI ADVANCE PROCESS TECHNOLOGIES PRIVATE LIMITED, Bengaluru, Kamataka (IN)

(72) Inventors: Sreeramagiri Venkata Shanmukha SOURI, Bangalore (IN); Chungikar Abbas SOHEL, Bangalore (IN); Sreeramagiri SIVAKUMAR, Bangalore (IN); Anapat SAMIR, Bangalore (IN)

(21) Appl. No.: 19/107,596

(22) PCT Filed: Aug. 22, 2023
(86) PCT No.: PCT/IB2023/058354

§ 371 Date: Feb. 28, 2025

(30) Foreign Application Priority Data
Sep. 9, 2022 (IN) 202241051515

(51) Int. Cl. B01F 25/433; B01F 25/431

(52) U.S. Cl. CPC B01F 25/4338; B01F 25/431971

(57) ABSTRACT

The invention discloses an apparatus with squeezing means for passive mixing of multi-phase flow or hydrodynamic performance that is housing a conduit/tube, which is a channel extending internally from the fluid inlet to the outlet ports, comprising stacked plurality of static-mixers with modified geometry to possess undulations or step-like geometry, which are responsible for alternate Squeezing and relaxation of flow through the conduit, which results in enhanced mixing of the multi-phasic flow. The conduit comprises of a plurality of stacked static-mixers which are axially or asymmetrically arranged across the length of the conduit, that can allow the fluid to pass through them continuously experiencing squeezing effect resulting in improved mixing, mass-transfer, and heat transfer.

### RELATED APPLICATIONS

This invention claims the benefit of priority to the Indian provisional patent application No. 202241051515 filed on the 9th of Sep., 2022, titled “APPARATUS WITH SQUEEZING MEANS FOR PASSIVE MIXING OF MULTIPHASE FLOW” and it is hereby incorporated by reference in its entirety.

### FIELD OF THE INVENTION

The present invention relates to static mixers that are specifically employed in systems involving multiphasic-flow and more particularly to static mixers containing stacked assembly of plurality of static mixers in a conduit that offers better mixing efficiency.

### BACKGROUND OF THE INVENTION

Static mixers are devices that can be placed in a conduit or tube present in a housing, with or without mixing elements and are devoid of moving parts. Static-mixers find application in a wide variety of areas such as reaction engineering, waste-water treatments, chemical processes involving blending and mixing etc. The mixing of the fluids that are passing through the tube or the conduit containing static mixers, can be enhanced to a greater extent either by the design of the static mixer, or by modifying the geometry or by incorporating suitable structural elements on the inner walls of the static mixer. The structural elements are immovable, fixed to the walls of the static mixer and are responsible for the enhanced mixing of the flow by way of twisting, splitting and offering resistance to the flow, thereby letting the contents of the fluids to mix intensely.

The mixing elements of a static mixers are fixed in nature which are mounted on the inner walls of the static mixer. Static-mixers have an edge over their counterparts namely dynamic-mixers as the latter ones have disadvantages of wear and tear and energy consumption due to mobility of the mixing elements. Mixing in a static-mixer as expressed earlier is ensured by manipulating the flow of the fluids inside the mixer. In such cases, the geometry of the static mixer, arrangement of the internal mixing elements, and nature of the surfaces that are in contact with the flow, play a vital role in enhancing the mixing characteristics and ultimately the interphasic mass transfer.

Static mixers find extensive applications in a variety of industrial environments that involve multiphasic systems such as liquid-liquid, liquid-solid, gas-liquid, gas-liquid-solid mixing. Static mixers are better suited for processes involving liquid, liquid mixing, or gas dispersion into a liquid wherein the bubble size and equated distribution of gas bubbles into the liquid are crucial for accomplishing the process. Modification of the geometry of the static mixer through which the multi-phasic fluid is flowing can result in enhanced mixing, mass transfer and heat-transfer and in turn improvement in the quality, purity of the final product, when used in multiphase reactions or extraction applications. Literature search reveals many references with regard to the designing of Static mixers and their suitability in improving flow-characteristics of multi-phasic systems.

EP3592835 disclosed a system for aerobic fermentation that included a vessel, an aeration system including a gas sparger fluidly coupled to the vessel to introduce a compressed gas to an internal volume of the vessel, and a recirculation loop fluidly coupled to an outlet of the vessel.

US patent 20190111402 described an improved apparatus for mixing intensification in multiphase systems, which can be operating in continuous or batch mode. In particular, it is related to a reactor, which can be assembled and disassembled easily for cleaning. The apparatus was based on oscillatory flow mixing (OFM) and comprised an oscillatory flow plate reactor (OFPR) provided with 2D Smooth Periodic Constrictions (2D-SPCs).

IN202121031526 disclosed a multiphase continuous flow reactor containing a screw conveyor, 3D splitting-remixing and wall scraping. All these modules were used in solitary mode and/in combinations arranged in vertical or horizontal and in series or parallel configuration with/without mixing mode as per the process requirement for critical operations.

A review by Akram Ghanema et al discussed Static mixers: Mechanisms, applications, and characterization methods (a chemical engineering research and design 9 2 (2 0 1 4) 205-228).

Sudhanshu Soman in his thesis titled Study of Effects of Design Modification in Static Mixer Geometry and its Applications (submitted to Waterloo, Ontario, Canada,2016), opined that the mixing performance can be improved either by designing new internal geometry or by modifying an existing static mixer geometry.

U.S. Pat. No. 4,763,727 discloses a panel heat exchanger that has a plate made of a heat conducting material and at least one pipe connected with it, this pipe having a meandering 5 shape, and through which a heat exchange medium flows, The p]ate is provided with slots the width of which is adapted to the diameter of the pipe. The pipe is inserted into the slots approximately flush with the plate and is held by deformations extending transversely its longitudinal axis at the slot edges in a form-fitting way, As mentioned in the descriptions, the deformations introduced in U.S. Pat. No. 4,763,727 created continuous contact surfaces between the pipe 10 and the carrier plate that ensured a good heat transfer & mass transfer.

U.S. Pat. No. 6,920,917 disclosed an inexpensive double-pipe heat exchanger having high performance. It comprised an inner pipe and an outer pipe which constitute a double pipe without adding a heat-transfer facilitating material such as an inner fin. In the double-pipe 15 heat exchanger having the inner pipe and the outer pipe, the outer pipe is dented from its outside toward its inside, thereby forming a plurality of projections which are dented toward the inner pipe. Examples of shapes of the projection are substantially conical shape. substantially truncated shape, substantially spherical surface shape, substantially cylindrical shape, substantially elliptic cylindrical shape and the like. The heat transfer performance is not deteriorated because a distance between the inner pipe and the outer pipe is substantially equally maintained by the projections of the outer pipe disposed around the inner pipe.

WO2014167506A disclosed a pinched pipe Flow reactor to prevent back-mixing and to enhance heat transfer. The reactor comprises a pipe having al least two converging/pinched section connected to each other by a non-pinched section ^{[101]} characterised in that axis of each converging/pinch section is between 10-90° and arranged in different perpendicular planes to the pinch. A method of enhancing mixing, mass transfer and heal transfer comprising the pinched pipe Flow reactor is disclosed.

In the light of the above reports, it is clear that mixing efficiency can be enhanced by way of squeezing the flow in a static mixer. Mixing efficiency can be enhanced considerably by changing the geometry of the static mixers suitably that can result in enhanced mass-transfer and heat-transfer in a static mixer by way of bringing about an alternate squeezing and relaxation mechanism particularly with respect to gas-liquid, liquid-liquid dispersions. Here the geometry of the static mixer results in the change of the bubble/droplet size (of dispersed phase in continuous phase) and hence, mass transfer characteristics of a multi-phasic flow in the tube.

Hence there is lot of scope to probe further to come out with a static mixer that ensures thorough mixing, purity, and yield of the product in multi-phasic flow systems involving gas-liquid, gas-liquid-solid dispersions by suitably modifying the geometry and structure of the static mixer used for passive-mixing.

Keeping all the above aspects in mind, the instant invention of “Apparatus with squeezing means for passive mixing of Multi-phase flow” is conceived to achieve improved multi-phase flow performance or hydrodynamic performance in a static mixer, by suitably modifying the structure or geometry of the static mixer that brings about a squeezing effect on the flow when used for such operations.

### BRIEF DESCRIPTION OF THE FIGURES

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labelled in every figure.

FIG. 1 depicts the 3D image of the apparatus with squeezing means for intensifying the multi-phasic flow.

FIG. 2 shows Undulated squeeze static mixer giving the cross-sectional view of the apparatus with squeezing means wherein the assembly of stacked individual mixers and their arrangement in a conduit wherein the squeezing action is realized by way of the undulated structure showing the alternating expanded and constricted zones. The 3D image of the Squeeze pattern for static mixing of fluids is depicted herein. A horizontal and Vertical squeeze patters is repeated through the length of the process side.

FIG. 3 shows Step squeeze design static mixer giving the cross-sectional view of the apparatus with squeezing means wherein the assembly of stacked individual mixers and their arrangement in a conduit wherein the squeezing action is realized by way of the stepped structure of the mixer that is shaped into alternating expanded step-like zones and constricted zones. 3D image of the Squeeze pattern for static mixing of fluids is depicted. A horizontal and Vertical squeeze patterns are repeated through the length of the process side.

FIG. 4: shows The Front view of FIG. 2 of the static mixer with undulations.

FIG. 5: shows the Right trimetric view of FIG. 2 of the static mixer with undulations.

FIG. 6: shows the Left trimetric view of FIG. 2 of the static mixer with undulations.

FIG. 7: shows the Section view of FIG. 2 showing the changing cross-section of the static mixer with undulations, from lateral squeeze to vertical squeeze and back.

FIG. 8 gives the Left trimetric view of FIG. 3 of the static mixer with step-structure that offers squeezing action.

FIG. 9 gives the Front view and the isometric views of FIG. 3 of the static mixer with step-structure that offers squeezing action.

FIG. 10 gives the Section view of FIG. 3 showing the changing cross-section of the static mixer with step-structure that offers squeezing action.

FIG. 11: shows one aspect of the of FIG. 3 showing a static mixer with 3 identical step sections with angular spacings.

FIGS. 2 & 3 depict the cross-sectional view of the apparatus with squeezing means for enhancing the mixing efficiency of passive flow, wherein an assembly of the stacked individual static mixers are arranged in a conduit or tube forming a channel between the inlet ports and the outlet port wherein the mixing action is enhanced due to the undulated and step like geometrical modifications present in the individual static mixers that are stacked together in the conduit.

### OBJECTIVES OF THE INVENTION

1. To come out with an apparatus with squeezing means for the intensification of passive mixing of a multiphasic flow by way of modifying the geometry of the static mixer.
2. To come out with an apparatus with squeezing means for the intensification of passive mixing of a multiphasic flow by way of modifying the geometry of the static mixer wherein the squeezing effect is achieved by suitably modifying the geometry of the static mixer in such a way that the multiphasic flow experiences alternate relaxations and contractions in a conduit all along from the inlet port to the outlet port in a housing.
3. To come out with an apparatus for the intensification of passive mixing for multi-phasic systems to achieve higher yields, maximum purity of the final product by way of modifying the geometry of the individual static mixers that can be stacked in a conduit or tube.

### SUMMARY OF THE INVENTION

The exemplary embodiment of the invention discloses an apparatus with squeezing means for passive mixing of multi-phase flow or hydrodynamic performance that is housing a conduit/tube, which is a channel extending internally from the fluid inlet to the outlet ports, comprising stacked plurality of static mixers with modified geometry to possess undulations or step-like geometry, that is responsible for alternate compression and relaxation of flow through the conduit, bringing about the squeezing effect on the flow. The squeezing effect results in enhanced mixing of the multi-phasic flow. The conduit comprises of a plurality of axially or asymmetrically stacked static mixers across the length of the conduit that can allow the fluid to pass through them continuously experiencing squeezing effect resulting in improved mixing, mass-transfer, and heat transfer.

Another embodiment of the instant invention discloses a step-wise or ramp like geometry at entry and exit points of the individual static mixers that improves the mixing efficiency, and in turn heat transfer in multi-phasic flow systems.

One embodiment of the invention wherein Multiple Static mixers can be stacked axially to enhance the mixing and dispersion of the multiphase flow elements. Each stacked element can be offset axially with the surface normal vectors of the plateaus rotated by an angle to squeeze flow in different directions.

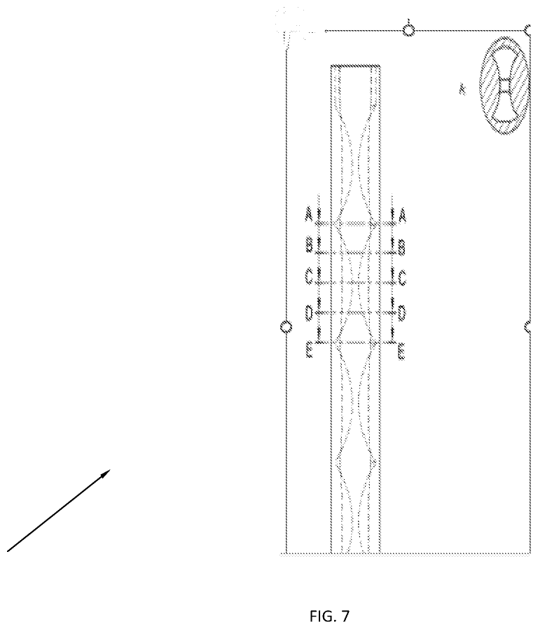

Yet another embodiment of the invention is related to description of Flow or hydrodynamic performance or hydrodynamic characteristics and its influence on the process-adaptability in manufacturing processes. Here, the fluid is squeezed when the cross section is changing from circular to a segment of a circle till the flow reaches the middle of the plateau. Then the fluid is allowed to expand with the cross section changing from a segment of a circle to a full circle at the end of the mixer element as given in FIG. 7. This design is suitable for manufacturing processes involving multiphase flow.

Another important embodiment of the invention stresses on the importance of the step like geometry of static mixers that have been stacked in the conduit in the housing. The step like structures provide a surface for the gaseous phase to adhere to and the gaseous phase can be easily dispersed by the liquid phase getting impinged on the step structures.

One more embodiment of the invention discloses enhancement of the heat transfer of the fluid to exterior of the mixer due to the high turbulence and localized eddies formed in the flow regime, and also the invention further discloses increasing mass transfer between the liquid and gaseous phases due to the promotion of the sloshing of the fluid around the step-like geometry of the static-mixer.

The various embodiments of the instant invention of “Apparatus with squeezing means for passive-mixing of a multiphasic flow” are described in detail drawing reference to the accompanying figures in the following paragraphs. The various embodiments of the invention clearly stress upon the novelty, inventorship and utility aspects of the instant invention compared to the prior art reported hitherto. A person with ordinary skill can easily understand and perform the invention easily. The different aspects of the instant invention as disclosed herein are only illustrative in nature and various other embodiments and working of the invention are possible with in the scope of the invention with out deviating from the essence of the invention.

### DETAILED DESCRIPTION OF THE INVENTION

The examples of the apparatus discussed herein are not limited in application to the details of construction and the arrangement of components set forth in the following description or illustrated in the accompanying drawings. It will be understood by one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting.

Any references to examples, embodiments, components, elements or acts of the apparatus herein referred to in the singular may also embrace embodiments including a plurality, and any references in plural to any embodiment, component, element, or act herein may also embrace embodiments including only a singularity (or unitary structure). References in the singular or plural form are not intended to limit the presently disclosed apparatus, its components, acts, or elements.

The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. The various embodiments of invention are described in detail herein and the various aspects of the invention are disclosed below.

Undulated squeeze static mixer is a monolith static mixer for mixing of multiphase flow comprising of a biconcave cross-sectional flow area wherein the vertical bi-concave area transforms into a horizontal bi-concave cross-section. This transformation takes place in the first half of the static mixer. The remainder of the static mixer's length is used to bring the flow back to its original configuration.

Step-squeeze static mixer is a monolith static mixer for mixing of multiphase flow comprising stepped ramp like geometry of the individual static mixer that enhances the passive mixing of the multi-phasic flow by squeezing means. This transformation takes place in the first half of the static mixer. The remainder of the static mixer's length is used to bring the flow back to its original configuration.

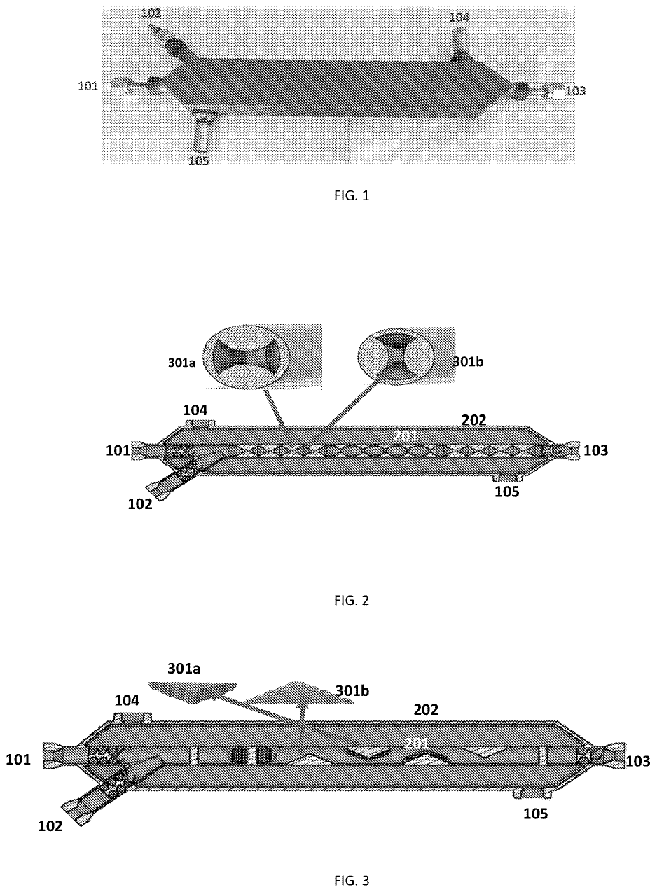

Drawing reference to FIG. 1, which clearly depicts the overall 3D image of the apparatus that is being used for intensifying the mixing in a multi-phasic flow that houses a conduit comprising stacked plurality of static mixers with modified geometry that is responsible for alternate compression and relaxation of flow through the conduit, bringing about the squeezing effect on the flow. The squeezing effect results in the enhanced mixing of the multi-phasic flow. FIG. 1 gives the overall picture of the apparatus housing a conduit/tube, the channel extending internally from the fluid inlet to the outlet ports comprising stacked plurality of static mixers. Here 101 & 102 indicate the process fluid(s) inlet ports, 103 indicates process fluid outlet port. 104 and 105 indicate utility fluid inlet and outlet ports respectively. The conduit comprises of a plurality of stacked static mixers across the length of the conduit that can allow the fluid to pass through them continuously experiencing a squeezing effect ensured by the individual static mixers whose geometry is suitably modified as is depicted in FIGS. 2 and 3.

Drawing reference to FIG. 2, the specific embodiment shows the cross-sectional view of the apparatus with squeezing means comprising the stacked Undulated squeeze static mixers wherein the assembly of stacked individual mixers and their arrangement in a conduit is depicted. Herein the squeezing action is realized by way of the undulated structure showing the alternating expanded and constricted zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Squeeze pattern for static mixing of fluids is clearly depicted herein. A horizontal and vertical squeeze pattern is repeated through out the length of the process side. Here 201 represents the Metal Wall of the inside tube containing static mixers and the flow volume for process fluid, whereas 202 is the outer casing of the wall. 301a & b represent the blow-up images of the flow path through the undulated squeeze static mixer. The unshaded area indicates the path for fluid flow.

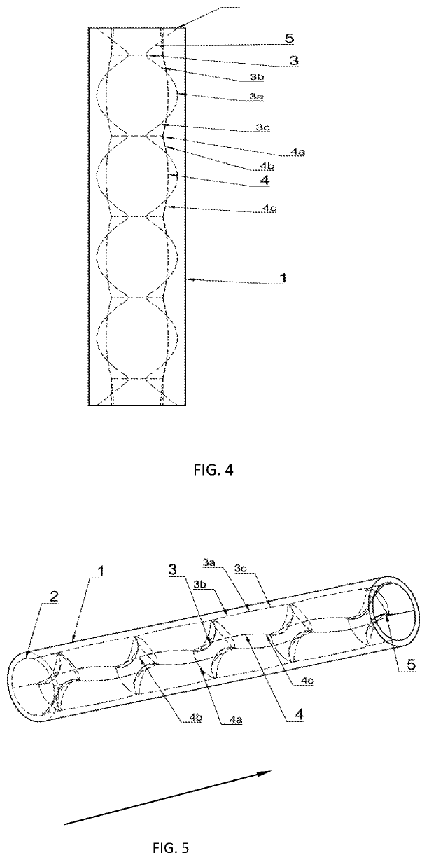

The apparatus housing the stacked plurality of undulated squeeze static mixers can be further clearly understood drawing reference to the embodiments as depicted in FIGS. 4-7. The different embodiments as depicted in FIGS. 4-7 pertaining to the stacked undulated squeeze static mixers as represented for the first time in FIG. 2 can be better understood taking the guidance parameters as given hereunder to clearly understand the geometrical views of the individual undulated static mixers that bring about the squeeze effect on flow in the conduit resulting in the enhanced passive-mixing efficiency.

The labels are common for all further images and represent the stated features for every static mixing unit. (Reference convention: feature labelled as 3 in FIG. 1a is to be referenced as 1a_3)
Label Entity 1: Outer Diameter of the surrounding pipe of the static mixer which is cylindrical in nature
Label Entity 2: Inner Diameter of the surrounding pipe that is cylindrical in nature.
Label Entity 3: Innermost circumference of the lateral squeeze surface of the static mixer.
3a: Outermost circumference of the lateral squeeze surface.
3b: Region of expansion/relaxation of cross section in lateral direction.
4: Innermost circumference of the vertical squeeze surface of the static mixer.
4a: Outermost circumference of the vertical squeeze surface.
4b: Region of expansion/relaxation of cross section in vertical direction.
4c: Region of constriction/squeeze of cross section in vertical direction.
5: Innermost circumference of the converging ramp leading to the squeeze cross-section provided for the feasibility of additive manufacturing.

One aspect of the invention as depicted in FIG. 2 is further illustrated in FIG. 4 which gives the Front view of the individual undulated static mixer: Hidden edges (cross-section changes) are depicted as dashed lines. Flow direction is also shown and is along the length of the tube. Individual static mixer elements are stacked in succession to give enhanced mixing effects. This view shows the change of surface and squeezing effect in the lateral direction (FIG. 4 1_3, 2_3). Additional regions of the surface have been labelled for ease of understanding (2_3a,2_3b,2_3c).

Another aspect of the invention as depicted FIG. 2 is further illustrated in FIG. 5 which gives the Right trimetric view of the individual undulated static mixer, with hidden edges depicted as dashed lines. Flow direction is also shown and is along the length of the tube. Individual static mixer elements are stacked in succession to give enhanced mixing effects. This view is to better understand the structure of the static mixer surface and the nature of its changes. From this view, primarily the lateral squeeze cross sections are in focus (4_3, 4_3a, 4_3b, 4_3c) along with the converging ramp (4_5).

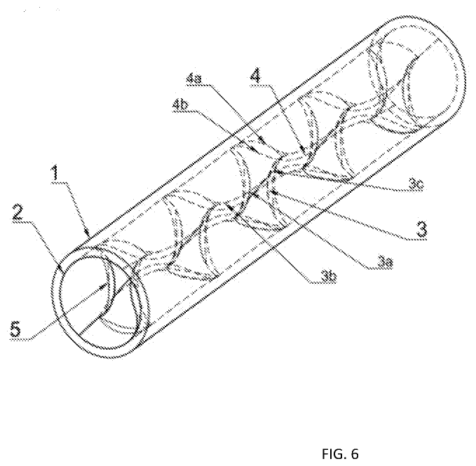

One more aspect of the invention as depicted in FIG. 2 is further illustrated in FIG. 6 which gives the Left trimetric view of the individual undulated static mixer, with hidden edges depicted as dashed lines. Flow direction is also shown and is along the length of the tube. Individual static mixer elements are stacked in succession to give enhanced mixing effects. This view is to get a better understanding of the structure of the static mixer surface and the nature of its changes. From this view, primarily the vertical squeeze cross sections are in focus (5_4, 5_4a, 5_4b, 5_4c) along with the converging ramp (5_5).

One extraordinary aspect the invention as depicted in FIG. 2 is further illustrated in FIG. 7 which gives the Section view of the individual undulated static mixer showing the changing cross-section of the static mixer, from lateral squeeze to vertical squeeze and back. Five Sections are made and spread across the length of one mixer element. They are labelled as follows: Section A: Section at the inlet of the mixing element, showing full Vertical squeeze, with lateral relaxation. Section B: Section in the first half of the mixing element, showing a transition from vertical squeeze to lateral squeeze. Corresponds to 2_3c, 3_3b, where there is increasing lateral constriction and vertical relaxation. Section C: Mid-Section of the static mixing element that shows maximum lateral squeeze/constriction and vertical relaxation. Section D: Section in the second half of the mixing element, showing a transition from lateral squeeze back to vertical squeeze. Corresponds to 2_3b, 3_3c, where there is increasing vertical constriction and lateral relaxation. Section E: Final cross-section of the mixing element, identical to the inlet surface, with maximum vertical squeeze, and lateral relaxation.

The exemplary aspects of the invention as depicted in FIG. 2 which are further illustrated in FIG. 7 can have additional embodiments that can further enhance the mixing efficiency in a multi-phasic passive flow. These aspects of the invention can also be a part of additional embodiments of the invention comprising varying entry length and the exit length of the mixer; having asymmetric cross sectional bi-concavity; with mixer elements placed eccentrically to the axis of the pipe; the bi-concave cross section being made using an n-sided polygon, where n>3; and the twist in transformation in terms of an angle θ, wherein 45°θ≤90°.

One preferred embodiment of the invention discloses an apparatus with squeezing means for enhancing mixing efficiency of a multi-phasic flow wherein the squeezing of the multi-phasic flow in the conduit or tube or channel is effected by the step-like geometry of the individual static mixers that are stacked together across the length of the conduit as is depicted in the cross-sectional view in FIG. 3.

Drawing reference to FIG. 3, it shows Step squeeze design static mixer giving the cross-sectional view of the apparatus with squeezing means wherein the assembly of stacked individual static mixers and their arrangement in a conduit, wherein the squeezing action is realized by way of the stepped structure of the mixer that is shaped into alternating expanded step-like zones and constricted zones. The 3D image of the Squeeze pattern for static mixing of fluids is depicted in FIG. 3 wherein horizontal and Vertical squeeze patterns are repeated through the length of the process side. Here 201 represents the Metal Wall of the inside tube containing static mixers and flow volume for process fluid, whereas 202 is wall outer casing. 301 a & b represent the blow-up image of the flow path through the step-squeeze static mixer. The unshaded area indicates the path for fluid flow. The dimensions of the conduit of the of the apparatus comprising stacked step-squeeze static mixers on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side the parameters are thickness is 2 mm; width is 38 mm; Inlet and outlet nozzle diameter is 10 mm; shape is rectangular; The 3D image of the Squeeze pattern for static mixing of fluids is clearly depicted herein in FIG. 3 wherein horizontal and vertical squeeze patterns are repeated through the length of the process side. Here 201 represents the Metal Wall of the inside tube containing static mixers and the flow volume for process fluid, whereas 202 is the outer casing of the wall. 301a & b represent the blow-up images of the flow path through the stepped-squeeze static mixer. The unshaded area indicates the path for fluid flow.

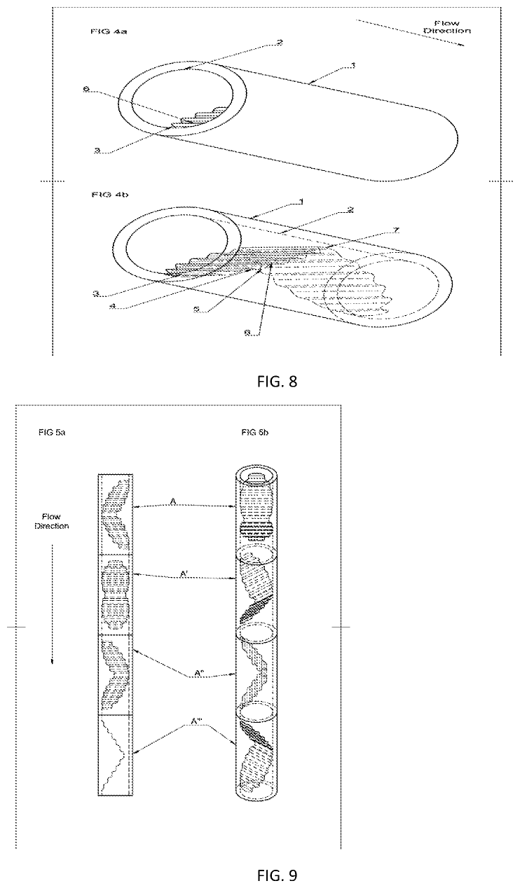

The apparatus housing the stacked plurality of step-squeeze static mixers can be further clearly understood drawing reference to the embodiments as depicted in FIGS. 8-11 that clearly throw light on the squeezing-effect ensured by the stepped geometry of the individual static mixers that have been stacked. The different embodiments as depicted in FIGS. 8-11 pertaining to the stacked stepped-squeeze static mixers as represented for the first time in FIG. 3 can be better understood taking the guidance parameters as given hereunder to clearly understand the geometrical views of the individual stepped-static mixers that bring about the squeeze effect on flow in the conduit resulting in the enhanced mixing efficiency passively.
Label Entity 1: Outer Diameter of the surrounding pipe of the static mixer which is cylindrical in nature.
Label Entity 2: Inner Diameter of the surrounding pipe which is cylindrical in nature.
Label Entity 3: Edge corresponding to the beginning undulation of the static mixer.
Label Entity 4: Axial Plateau (flat surface) of each step of the static mixer, determines the height of each step.
Label Entity 5: Curved Surface (fillet) between consecutive steps.
Label Entity 6: Curved Surface (fillet) of the edge of each individual step.
Label Entity 7: Central axial plateau (flat surface), is the section between the constricting and relaxing ramps regions of the static mixer

One preferred embodiment of the invention as depicted in FIG. 3 can be better understood as illustrated in FIG. 8 that gives the left trimetric views with only visible edges depicted and with hidden edges depicted. Here FIG. 8. 4a gives the Left trimetric view of the static mixer: with only visible edges depicted along with the flow direction. From this view, an understanding of the external 3-dimensional structure of the static mixer can be derived. FIG. 8 4b gives the Left trimetric view of the static mixer, with hidden edges depicted as dotted lines along with the flow direction. From this view, a deeper understanding of the internal 3-dimensional structure of the static mixer can be derived.

One more aspect of the invention as depicted in FIG. 3 is illustrated in FIG. 9 that gives the front and isometric views of a tube comprising stacked static mixers having stepped geometry. Here FIG. 9. 5a gives the Front view of a tube with stacked static mixers. This is a representative of the implementation of multiple mixers in series. Each element is arranged with an offset angle with the prior, to provide varying directions of squeeze to the working fluids. Each individual element is labelled with a different number of apostrophes along with a letter for the type of missing element. (5_A, 5_A′, 5_A″,5_A″′). FIG. 9: 5b gives the Isometric view of a tube with stacked static mixers having stepped geometry. This is a representative of the implementation of multiple mixers in series. The 3-dimensional arrangement can be better understood from this image. Each element is arranged with an offset angle to the prior, to provide varying directions of squeeze 4 to the working fluids. Each individual element is labelled with a different number of apostrophes along with a letter for the type of missing element. (5_A,5_A′, 5_A″,5_A″′).

One aspect of the invention as depicted in FIG. 3 can be better understood through FIG. 10 that gives a section view of the static mixer with stepped geometry. The Section view as is illustrated in FIG. 10 shows the changing cross-section of the static mixer, from the entry to maximum squeeze and back. 3 Sections are made, spread across the length of one mixer element. They are labelled as given below:
Section A: Section at the inlet of the mixing element, showing the frontal surface of the static mixer as experienced by the fluid.
Section B: Mid-Section of the static mixing element that shows maximum lateral squeeze/constriction with the smallest opening for fluid. This segment is formed by the inner surface of the cylinder and the central plateau.
Section C: Intermediate segment of the static mixer in the second half showing the expansion area provided to the working fluids.

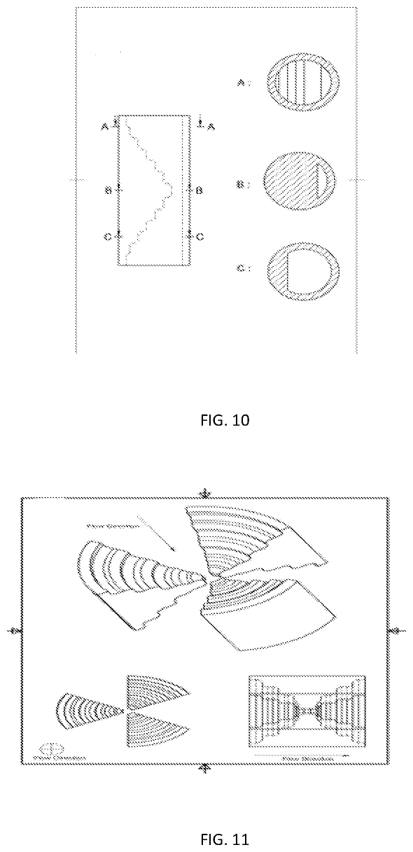

One important aspect of the invention as depicted FIG. 3 can be understood as is illustrated in FIG. 11. This embodiment consists of 3 identical stepped-geometry sections with angular spacings. It is radially symmetrical and forces the fluid to move into the central cavity and angular spacings. By stacking the elements successively with angular offsets further mixing can be achieved.

Various other Embodiments of the stacked plurality of static mixers with step-geometry can be realized by varying the lengths of each step; the extent of the squeeze as a function of the number of steps and the height of each step, thereby the ratio Squeeze C/S Circular C/S can be controlled by varying these parameters; by varying the length of the entry region and the exit region, and also varying the width of the static mixer such that w can be 0.1×D<ω<1×D. The static mixers can as well repeat circumferentially as can be inferred from FIG. 11 that forms yet another important embodiment of the invention as is contained in FIG. 3.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example.

Furthermore, various modifications and rearrangements of the parts may be made without departing from the spirit and scope of the underlying inventive concept. For example, the geometric configurations disclosed herein may be altered depending upon the application, as may be the material selection for the components. Thus, the details of these components as set forth in the above-described examples, should not limit the scope of the claims.

The apparatus with squeezing means for enhancing the mixing efficiency of a multiphasic flow comprising a stacked plurality of static mixers geometrically modified to effect alternate relaxations and contractions by way of undulations, step-geometry are produced as per the detailed description as disclosed by the instant invention and are tested to evaluate their mixing efficiency experimentally taking water-acetic acid-toluene system and the results are compared with those obtained from experiments conducted on similar lines in batch mode as well as in a tube reactor. The experimental results are given in the following paragraphs.

Mass transfer studies are conducted using the “Apparatus with squeezing means for passive mixing of a multiphase flow” or Static mixer reactors (SMR) as disclosed by the invention to assess and quantify the mixing capabilities of the apparatus or the reactors. Liquid-liquid extraction (LLE) is the physical method employed to ascertain the effective interphase mass transfer in a given system (reactor or mixed vessel or SMR).

The liquid-liquid extraction of the ternary system of water-acetic acid-toluene, is studied in a batch system to obtain equilibrium concentration. The same extraction is performed using the apparatus contained in the instant invention to establish their mass transfer efficiency. Similar experiments were conducted in an empty tubular reactor (without the static mixers as disclosed by the instant invention) with a T-joint, to establish the base line mass transfer coefficients without the static mixers. Mass transfer coefficients are evaluated for the liquid-liquid-extraction of water-acetic acid-toluene in a flow system using the apparatus comprising the stacked static mixers with modified geometry as disclosed in the invention. The enhanced efficiency of, the stacked plurality of the static mixers present inside the apparatus as contained in the instant invention is evaluated by comparing the experimental results.

### Example 1

### Batch Experiment to Establish the Equilibrium Between Toluene and Water Phase for Acetic Acid(AA) Partition

Equal volumes (50 mL) of 30 w/w % Acetic Acid in water (feed, raffinate) and Toluene (extractant) are taken in a Round bottom flask. The mixture is kept for stirring at 950 rpm. Samples are collected for every fifteen minutes, and the mixture is transferred to separating funnel where the ternary system gets separated into two definite layers namely, top organic layer which is toluene dominant and the bottom aqueous layer that is water dominant. Acetic acid content in both the layers is analysed by titrating known amount of sample against 1N NaOH. 15 mL of methanol and water are used as solvents for titrating the organic and aqueous layers respectively. The amount of NaOH consumed is used to determine Acetic acid % in both the layers by using equation 1

$$wt / wt \% Acetic Acid = \frac{\begin{matrix}{N}_{NaOH} \times Vol of NaOH consumed \times \\ Molecular Weight of Acetic Acid\end{matrix}}{10 \times Weight of sample taken} \qquad eqn . 1$$

Burette reading gives the value for the Vol of NaOH consumed in mL. Samples are collected until repetitive burette readings occur. Content of acetic acid taken as normality is used to calculate Partition coefficient (K_{D}) and Mass transfer coefficient (K_{L}a) which is given by equation 2 and 3 respectively.

$${K}_{D} = \frac{[ A {A}_{org} ]}{[ A {A}_{a q} ]} \qquad eqn . 2$$

Where, [AA_{org}] is the concentration of acetic acid in organic phase and [AA_{aq}] implies concentration of acetic acid in aqueous phase. Using the equilibrium concentration and the initial concentration of the solute AA in both the phases the mass transfer coefficient for an interphase mass transfer is calculated according to the equation 3. This will be used in subsequent sections for SMRs.

$${K}_{L} a = \frac{1}{τ} ln ( \frac{{C}_{i n} - {C}^{*}}{{C}_{out} - {C}^{*}} ) {min}^{- 1} \qquad eqn . 3$$

Where Cᵢₙ, Cₒᵤₜ are the concentrations of the solute in inlet, outlet of the reactor at time τ and C* is the equilibrium concentration. The data obtained from batch studies is summarised in table1. From table1, it can be observed that between 75 to 150 min, the concentration of AA in organic phase remained constant which indicated the attainment of the equilibrium between the two layers. The average concentration of AA in Organic (toluene) phase is taken as the equilibrium concentration and it is found to be 0.634N. This is used as C* in the equation 3 to calculate mass transfer coefficient for all the subsequent calculations for the apparatus comprising static mixer reactors (SMRs).

TABLE 1
Batch study data
Concentration of AA in toluene layer as function
of time of contact in a batch system

| Time | wt % AA | [AA], Normality |
|---|---|---|
| 0 | 0.000 | 0.000 |
| 15 | 2.227 | 0.371 |
| 30 | 1.565 | 0.391 |
| 45 | 3.056 | 0.509 |
| 60 | 3.571 | 0.595 |
| 75 | 3.881 | 0.646 |
| 90 | 3.750 | 0.625 |
| 105 | 3.870 | 0.644 |
| 120 | 3.853 | 0.642 |
| 135 | 3.781 | 0.630 |
| 150 | 3.709 | 0.618 |

| | |
|---|---|
| Equilibrium | |
| concentration of AA in | 0.634N |
| Toluene organic layer | |

### Example 2

Studies Conducted with the Apparatus Containing Undulated and Stepped Static Mixer Reactors(SMRS) in a Housing Experimental Setup

Liquid-liquid extraction procedure was carried out in SMRs to determine mass transfer coefficient by physical method. Two pumps, a separating funnel, and the SMR constituted the experimental setup. Calibrated metering pumps were used to pump known and desired flow of both the solvent and the feed solution. They enter the SMR, get mixed due to the static mixers (SMs) in the reactor and exchange takes place between immiscible organic and aqueous phases. The outlet of the SMR is connected to a separating funnel, where both phases collect and separate immediately, thereby stopping further exchange of mass between the phases. Each sample that was taken was immediately separated, and the solute content of both the layers was determined. This experiment was carried out at six different residence times: 0.25,0.5, 1, 1.5, 2, 2.5 minutes, byvarying the flow rates of the two liquids. The ratio of flow rates of both phases was maintained constant at all time intervals.

### Experimental Procedure

The feed solution (30% Acetic Acid in water) and solvent (Toluene) are pumped into the SMRs. Here they flow concurrently getting intimately mixed due the presence of the novel SMs and resulting in the mass transfer of acetic acid between the two phases. The flowrates of the pumps are fixed according to residence time, which is given by equation 4.

$$Flowrate = \frac{Volume of reactor}{Residence time} \frac{mL}{min} \qquad eqn . 4$$

The collected mixture is left for separation into aqueous and organic layers. Both the layers are analysed for Acetic Acid content by taking 5 gm of sample and titrating it against 1N NaOH as discussed above. Equilibrium concentration is found by conducting batch studies. Mass transfer coefficient is calculated at each time of residence (τ) using equation 3.

The experimental results and the mass transfer coefficients obtained, for the empty tube, undulated and step SMRS are given below in tables 2, 3 & 4 respectively.

TABLE 2
Estimation of mass transfer coefficients for empty tube with a T-Joint (baseline “flow” reactor)

| | organic layer | | | | | aqueous layer | | | | | | |
|---|---|---|---|---|---|---|---|---|---|---|---|---|
| | | 1.0N | Calcu- | | | | 1.0N | Calcu- | | | | Mass |
| Residence | wt of | NaOH | lated | wt % | Concetration | wt of | NaOH | lated | | Concetration | | transfer |
| time | sample | titre | wt % | AA | [AA org] | sample | titre | wt % | % AA | [AA aq] | Partition | coefficient |
| (min) | (gm) | value, ml | AA | avg | (N) | (gm) | value, ml | AA | avg | (N) | coefficient | min \hat{ }(−1) |
| 0.25 | 5.03 | 1.5 | 1.84 | 1.79 | 0.30 | 5 | 22.5 | 27.8 | 27.84 | 4.636 | 0.064 | 2.501 |
| | 5.01 | 1.4 | 1.73 | | | 5.02 | 22.6 | 27.8 | | | | |
| 0.5 | 5.05 | 1.7 | 2.08 | 2.03 | 0.34 | 5.03 | 22.3 | 27.4 | 27.57 | 4.590 | 0.074 | 1.501 |
| | 5.01 | 1.6 | 1.98 | | | 5 | 22.4 | 27.7 | | | | |
| 1 | 5.05 | 1.9 | 2.33 | 2.27 | 0.38 | 5.03 | 22 | 27.1 | 27.17 | 4.524 | 0.084 | 0.896 |
| | 5.01 | 1.8 | 2.22 | | | 5.01 | 22.1 | 27.3 | | | | |
| 1.5 | 5.02 | 1.9 | 2.34 | 2.40 | 0.40 | 5 | 21.9 | 27.1 | 27.04 | 4.504 | 0.089 | 0.653 |
| | 5.03 | 2 | 2.46 | | | 5.04 | 22 | 27.0 | | | | |
| 2 | 5.01 | 2.1 | 2.59 | 2.59 | 0.43 | 5.02 | 21.8 | 26.9 | 26.91 | 4.482 | 0.096 | 0.561 |
| | 5.01 | 2.1 | 2.59 | | | 5 | 21.8 | 27.0 | | | | |
| 2.5 | 5.06 | 2.2 | 2.69 | 2.64 | 0.44 | 5.02 | 21.7 | 26.7 | 26.74 | 4.454 | 0.099 | 0.464 |
| | 5.02 | 2.1 | 2.59 | | | 5.04 | 21.8 | 26.8 | | | | |

The first column is the residence time set for the articular run. This is for combined flow rates of the liquids and the tube volume is 40 ml. The next 5 columns show the estimation of the concentration of AA in organic layer estimated by titrating the isolated layer with 1N NaOH. Subsequent 5 columns under the Aqueous layer indicate the same estimation for aqueous layer. The column partition coefficient is derived from the equation 2 and the mass transfer concentration is estimated based on equation 3. Equilibrium concentration of AA in organic layer is 0.64N estimated earlier from the batch extraction experiments.

It is to be noted that for a fixed volume of reactor (here a tube), higher the residence time means lower the flow rates. Lower flow rate means less velocity of the liquids through the reactor. It is established in the science that higher the flow rate, better is the mixing and hence the mass transfer coefficient (m.t.c). The trend of m.t.c with residence time seen in the first and last columns of the above table indicate the same trend. Higher residence time, lower the flow rates, slower the velocity therefore lower the mass transfer coefficient. The trend asymptotically reaches a limit, which can be seen from the above data.

Using the same procedure, mass transfer coefficient for the two SMRs is estimated. Tables 3. & 4 summarise the data obtained from undulated and Step squeeze and combine SMR designs respectively.

TABLE 3
Experimentally Estimated mass transfer coefficient
for different residence times for undulated SMR
Undulated SMR

| | Mass transfer |
|---|---|
| Residence time | coefficient |
| (min) | min\hat{ }(−1) |
| 0.25 | 4.19 |
| 0.5 | 2.19 |
| 1 | 1.18 |
| 1.5 | 0.83 |
| 2 | 0.68 |
| 2.5 | 0.57 |

TABLE 4
Experimentally Estimated mass transfer coefficient
for different residence times for Step SMR

| | Mass transfer |
|---|---|
| Residence | coefficient |
| time (min) | min\hat{ }(−1) |
| 0.25 | 4.02 |
| 0.5 | 2.20 |
| 1 | 1.18 |
| 1.5 | 0.87 |
| 2 | 0.71 |
| 2.5 | 0.57 |

From tables2, 3 & 4 it can be concluded that continuous systems with SMRs undulations and step have higher mass transfer coefficient compared to empty Tubular reactor due to the presence of the geometrical modifications of the static mixers. This establishes the utility of the SM designs disclosed in the invention for interphase mass transfer devices.

### Advantages of the Invention

The apparatus with squeezing means for enhancing mixing efficiency of multi-phasic passive flow disclosed herein has the following advantages,
1. A significant improvement over prior art by providing an apparatus comprising a stacked plurality of static mixers that uniquely solves the problems of providing a superior mixing action in a multi-phasic flow
2. The apparatus disclosed herein ensures enhanced mass-transfer, heat-transfer and improved mixing and dispersion of gas-liquid systems with minimal pressure head loss downstream of the injection site.
3. The apparatus disclosed herein operates by squeezing means due to the undulations, step-like geometry of the static mixer offering a thorough mixing in multi-phasic systems and can be employed in process industries, as is exemplified from the experimental results obtained in the liquid-liquid-extraction studies done with water-acetic acid-toluene system wherein the invention provided better mass-transfer coefficient compared to the same done in a static mixer devoid of such geometrical modifications.
4. One important embodiment of the invention stresses on the importance of the step like structures of static mixers in the housing. The step like structures provide a surface for the gaseous phase to adhere to and the gaseous phase can be easily dispersed by the liquid phase getting impinged on the step structures.
5. The heat transfer of the fluid to exterior of the mixer is enhanced due to the high turbulence and vortices formed in the flow regime. The static-mixer with step like geometry promotes sloshing of the fluid, which increases the mass transfer between the liquid and gaseous phases.

### Analysis of Novelty, Inventiveness and Utility

The instant invention of “APPARATUS WITH SQUEEZING MEANS FOR PASSIVE MIXING OF MULTI-PHASE FLOW” is novel in the light of the prior art as it provides an apparatus or reactor comprising a stacked plurality of static mixers whose geometry is modified to have undulations, step-like geometry that considerably enhanced the mixing of a multiphasic-flow as is evident from the mass-transfer coefficients obtained from the liquid-liquid extraction studies done using water-acetic acid-toluene system. The inventiveness of the instant invention lies in arriving at the apparatus with squeezing means to enhance the mixing efficiency in multi-phasic flow systems by way of modifying the geometry of the static mixers that can be stacked in a conduit, which can be employed successfully in processes to obtain better yields. The various modification in the geometry of the static mixers as illustrated in the various embodiments of the instant invention are indicative of the inventiveness of the instant invention. The utility aspect of the instant invention is realized as the instant invention discloses an apparatus that can provide enhanced mixing efficiency in multi-phase flows and which can be successfully employed in chemical process industry for specialty chemicals, pharmaceutical intermediates and API production, polymer production wherein a thorough mixing of the different phases has a profound effect on the yield and purity of the final product.

What is claimed:

1. An apparatus with squeezing means for the passive mixing of a multi-phase(ic) flow or hydrodynamic performance comprising a housing, having a conduit/tube or a channel extending internally from the fluid inlet to the outlet ports that comprises of stacked plurality of static-mixers with modified geometry to possess undulations or step-like geometry, that is responsible for alternate compression and relaxation of flow through the conduit, bringing about the squeezing effect on the flow wherein,
a) The squeezing effect results in enhanced mixing of the multi-phasic flow,
b) The conduit comprises of a plurality of stacked static-mixers across the length of the conduit that can allow the fluid to pass through them continuously experiencing squeezing effect resulting in enhanced mixing, mass-transfer, and heat transfer,
c) The individual static-mixers are placed axially or asymmetrically along the length of the conduit.

2. The static-mixer with modified geometry to possess undulations as claimed in claim 1 is a monolith static mixer for mixing of multiphase flow comprising of a biconcave cross-sectional flow area wherein,
a) the vertical bi-concave area transforms into a horizontal bi-concave cross-section and the transformation takes place in the first half of the static mixer,
b) The remainder of the static mixer's length is used to bring the flow back to its original configuration.

3. The static mixer with modified geometry to possess step-like geometry as claimed in claim 1 is a monolith static mixer for mixing of a multiphase flow comprising of stepped ramp like geometry that enhances the passive mixing of the multi-phasic flow by squeezing means wherein,
a) The transformation takes place in the first half of the static mixer,
b) The remainder of the static mixer's length is used to bring the flow back to its original configuration.

4. The stacked plurality of static mixers as claimed in claim 1 wherein, the static mixers are stacked axially to enhance the mixing and dispersion of the multiphase flow elements, wherein each stacked mixer can be offset axially with the surface normal vectors of the plateaus rotated by an angle to squeeze flow in different directions.

5. The static-mixer with modified geometry to possess step like geometry as claimed in claim 1 wherein the step-like structures provide a surface for the fluid phase to adhere to and experience localized perturbations which enhance interphase mixing and mass transfer.

6. The enhanced heat transfer of a multi-phasic flow as claimed in claim 1 is due to the high turbulence and vortices formed in the flow regime.

7. The enhanced mass transfer of a multi-phasic flow as claimed in claim 1 is due to the promotion of the sloshing of the fluid around the step-like geometry of the static-mixer with modified geometry to possess step-like geometry.

8. The hydrodynamic performance of the apparatus as claimed in claim 1 making the apparatus adaptable in manufacturing processes wherein,
a) the fluid is squeezed when the cross section is changing from circular to a segment of a circle till the flow reaches the middle of the plateau,
b) then the fluid is allowed to expand with the cross section changing from a segment of a circle to a full circle at the end of the static-mixer,
c) subsequently the squeezing direction is changed perpendicularly to force the fluids to alter their flow path which causes the two phases to mix.

9. The enhanced passive mixing of a multi-phasic flow as claimed in claim 1 with stacked static-mixers with modified geometry to possess step-like geometry is further enhanced by varying,
a) the length of each step,
b) the extent of the squeeze as a function of the number of steps (as the ratio of C/S),
c) the extent of the squeeze as a function of the height of each step in the ratio of Circular to Squeeze (C/S),
d) the length of the entry region and the exit region,
e) the width (ω) of the static mixer such that ω can be 0.1×D<ω<1×D,
f) multiplying the number of static mixers with step-like geometry circumferentially.
g) the parameters governing the extent of squeeze.

10. The enhanced mixing of a multi-phasic flow as claimed in claim 1 when the conduit comprises of stacked static mixers with modified geometry to possess undulations is further enhanced by,
a) varying the entry length and the exit length of the static mixer,
b) introducing asymmetric cross-sectional biconcavity,
c) placing the static mixers eccentrically to the axis of the pipe,
d) changing the bi-concave cross section using an n-sided polygon, where n>3,
e) introducing a twist in transformation in terms of an angle θ, wherein 45°≤θ≤90°.
